(19) United States
(12) Patent Application Publication
(10) Pub. No.: US 2002/0013951 A1
(43) Pub. Date: Jan. 31, 2002

(54) Multi-position multimedia device for a motor vehicle

(76) Inventors: Alois Karl, Remchingen (DE); Wolfram Kohl, Keltern (DE); Joachim Wietzke, Karlsruhe (DE); Martin Raab, Karlsbad (DE)

Correspondence Address: Samuels, Gauthier & Stevens LLP, 225 Franklin Street, Suite 3300, Boston, MA, 02110, US

(21) Appl. No.: 09/791,396

(22) Filed: Feb. 22, 2001

(30) Foreign Application Priority Data
Feb. 22, 2000 (DE) 100 08 092.8

(51) Int. Cl. H04N 7/16

(52) U.S. Cl. 725/153

(57) ABSTRACT

A multimedia device for a motor vehicle includes a housing that defines a recess sized to accept a multimedia player. The multimedia player includes a front loading side through which recording media is loaded into and removed from the multimedia player. The multimedia player is pivotally fastened to housing so said multimedia player may pivot out from said housing at an angle of at least 90°. The multimedia device is preferably situated in the center console or mounted the front seats of the vehicle. Consequently, the front loading side of the multimedia player can be swung forward or backward in the vehicle, thus allowing the multimedia player to be operated conveniently both from either the front or rear seats. In addition, the multimedia player can conveniently be loaded and unloaded with recording media from either the front or rear seats.

### BACKGROUND OF THE INVENTION

The present invention relates to the field of multimedia devices and in particular to a multimedia device that includes a multimedia player that can be loaded and/or unloaded from either a front seat or a rear seat of a vehicle.

Multimedia equipment can include, for example, a multimedia device with a multimedia player (e.g., a CD or DVD). In a home unit, it is relatively simple to operate such a disk player. However, in a vehicle it is often difficult to operate a multimedia disk player because of the constricted spatial conditions. Furthermore, the multimedia player generally can be operated only from one seat (e.g., the front seat).

Therefore, there is a need for a multimedia device for use in a vehicle that can be operated from a plurality of seats (e.g., a front seat and a back seat).

### SUMMARY OF THE INVENTION

Briefly, according to an aspect of the present invention, a multimedia device for a motor vehicle includes a housing that defines a recess sized to accept a multimedia player. The multimedia player includes a front loading side through which recording media is loaded into and removed from the multimedia player. The multimedia player is pivotally fastened to the housing so that the multimedia player may pivot out from the recess at an angle of at least 90° relative to a top surface of the housing.

The multimedia device is preferably located either in the center console or between the front seats of the vehicle.

The multimedia player can be fastened to pivot in the area of the front side or a back side of the housing. For example, the back side of the multimedia player can be fastened to the front side of the housing. With this design, the multimedia player can be operated from the rear seat if it is swung from the recess about an angle which is less than 90°. If the multimedia player is swung out of the recess about an angle up to about 180°, it can conveniently be operated from the driver's seat or the front passenger's seat. Alternatively, the back side of the multimedia player can also be fastened to the back side of the housing. In this embodiment the multimedia player can be conveniently operated from the front seat if it is swung out of the recess by an angle up to 90°. If the player is swung out of the recess by a greater angle—up to about 180°—the player can be conveniently operated from the rear seats.

Advantageously, media can be inserted to or withdrawn from the multimedia player from either the front seat or the rear seat.

The system may also include a first control section for the multimedia device and/or the multimedia player, and possibly for other devices, is situated in the vicinity of the shift lever or at the shift lever of the vehicle.

The system may also include a first display mounted to dashboard of the motor vehicle, and a second display mounted to a back rest of a front seat and facing a back seat area of the motor vehicle to display information to occupants in the rear seat area. The first and second displays are connected to receive images and text to be displayed.

In addition, the multimedia system within the vehicle provides screens in the dashboard and in the back rests of the front seats, so that television can be viewed from every seat.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 illustrates a perspective view of a multimedia device with a multimedia player recessed therein;

FIG. 2 illustrates a simplified longitudinal section through the multimedia device, with the multimedia player swung out in a first position;

FIG. 3 illustrates a simplified longitudinal section through the multimedia device, with the multimedia player swung out in a second position; and

FIG. 4 shows a front side of a control section.

### DETAILED DESCRIPTION OF THE INVENTION

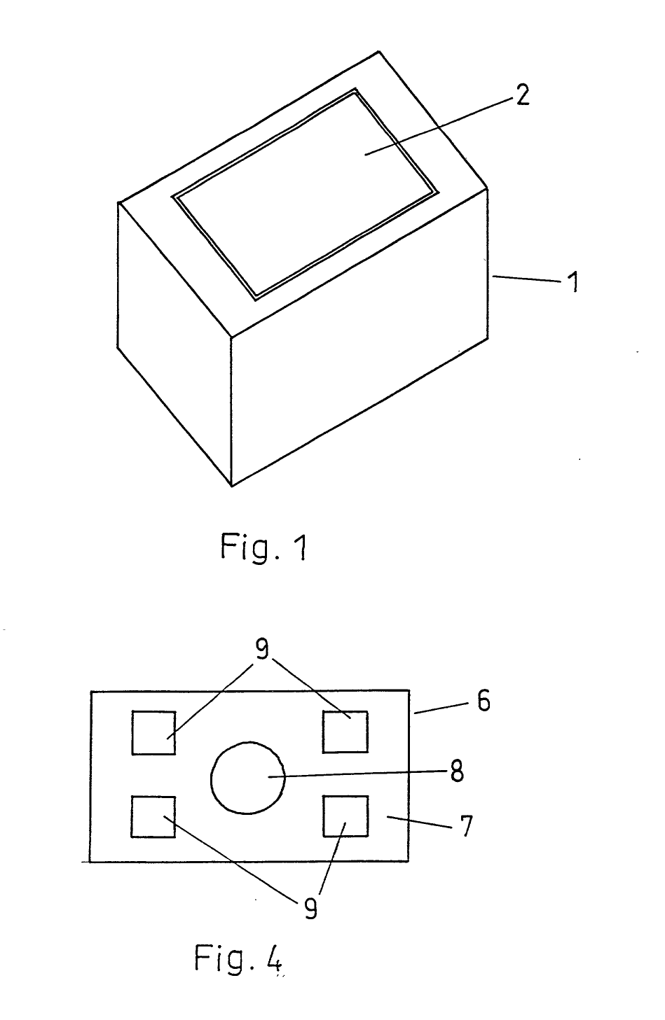

FIG. 1 illustrates a perspective view of a multimedia device 1 for use in a vehicle. The multimedia device includes a multimedia player 2 lowered in a recess 3 of the multimedia device housing.

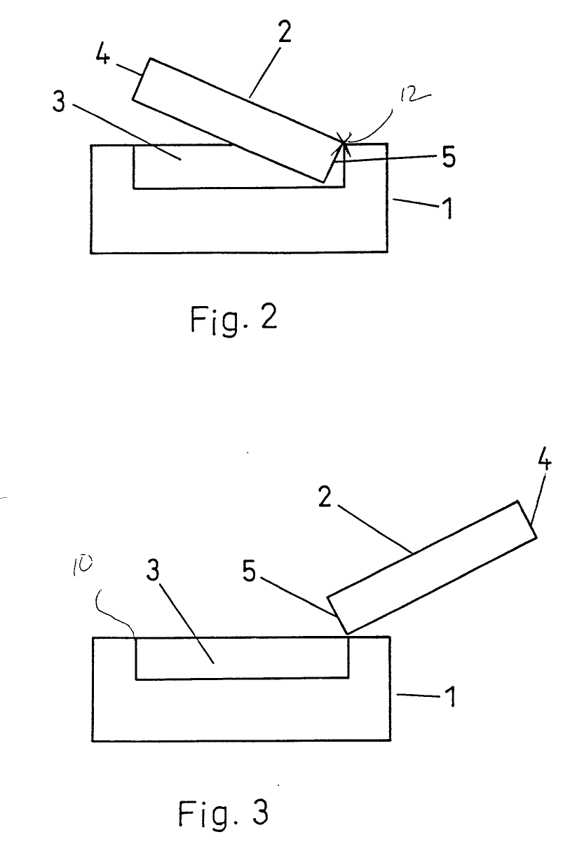

FIG. 2 illustrates a simplified longitudinal section through the multimedia device 1 with the multimedia player 2 swung out from the recess. The multimedia player 2 is swung out of the multimedia device 1 to an angle of about 30°. The multimedia player is secured to the multimedia device to pivot about pivot point 12. A front side 4 of the multimedia player points for example to the back seats of the vehicle. The multimedia player 2 can be swung back into the recess 3 or—as shown in FIG. 3—it can be swung out even further up to an angle of approximately 180°. In the position illustrated in FIG. 4, the front side 4 of the multimedia player 2 is conveniently accessible from the front seats. The back side 5 of the multimedia player 2 is pivotally fastened to the front side of the recess 3. However, in an alternative embodiment the multimedia player 2 can be pivotally connected to the housing at the back side of the recess 3 (e.g., a location 10).

In one embodiment, the multimedia player 2 can be held in various detent positions through its range of motion. This can be a continuous detent mechanism, or a stepped one, by for example 10°.

To operate the multimedia player 2, it can have several keys and knobs on its front side 4.

FIG. 4 illustrates a front side 7 of a control section 6 used to control the multimedia device and, where appropriate, other devices. For this purpose, several keys 9 and at least one knob 8 are operably positioned on the front side 7. A first control section is preferably situated in the vicinity of the shift lever and a second control section may be located in the armrest of the back seat.

The multimedia device is preferably situated in the center console or between the front seats of the vehicle.

Advantageously, since the multimedia player 2 is designed to pivot up to about 180°, it can be conveniently loaded with recording media from either the front seat or the back seat of the vehicle. In addition, positioning a first control section in the vicinity of the shift lever, and a second control section on the armrest of the back seat, the multimedia device 1 (and, when appropriate other devices) can be conveniently and fully operated from all seats.

The invention is especially suited for installation in motor vehicles such as a passenger car or bus.

Although the present invention has been shown and described with respect to several preferred embodiments thereof, various changes, omissions and additions to the form and detail thereof, may be made therein, without departing from the spirit and scope of the invention.

What is claimed is:

1. A multimedia device for a motor vehicle, comprising:
a housing that defines a recess sized to accept a multimedia player that includes a front loading side through which recording media is loaded into and removed from said multimedia player, wherein said multimedia player is pivotally fastened to said housing so that said multimedia player may pivot out from said recess at an angle of at least 90° relative to a top surface of said housing.

2. The multimedia device of claim 1, wherein said multimedia player may be positioned within said recess of said housing such that a top surface of said multimedia player is flush with a top surface of said housing.

3. The multimedia device of claim 1, wherein said multimedia player comprises a front loading side substantially perpendicular to said top surface, wherein said front loading side comprises control input devices to operate said multimedia player.

4. The multimedia device of claim 1, further comprising:
a first control section mounted in the vicinity of a motor vehicle shift lever in a front seat area of the vehicle; and
a second control section mounted to an arm rest located in a rear seat area of the vehicle;
wherein said first and second control sections control said multimedia device.

5. The multimedia device of claim 4, wherein said multimedia player can be swung out into detent positions.

6. The multimedia device of claim 2, wherein a back side of said multimedia player is pivotally fastened to a front of said housing.

7. The multimedia device of claim 4, wherein said front loading side comprises a plurality of multimedia control inputs to control said multimedia device.

8. The multimedia device of claim 7, wherein said control inputs include at least one rotary knob and a plurality of keys.

9. The multimedia device of claim 8, further comprising:
a first display mounted to a dashboard of the motor vehicle; and
a second display mounted to a back rest of a front seat and facing a back seat area of the motor vehicle to display information to occupants in the rear seat area;
wherein said first and second displays are connected to receive images and text to be displayed.

10. The multimedia device of claim 8, wherein said multimedia player comprises a CD player.

11. The multimedia device of claim 8, wherein said multimedia player comprises a CD-ROM player.

12. The multimedia device of claim 8, wherein said multimedia player comprises a DVD player.
